(19) United States
(12) Patent Application Publication
(10) Pub. No.: US 2022/0003723 A1
(43) Pub. Date: Jan. 6, 2022

(54) METHOD FOR TRANSFERRING A RADIOISOTOPE BETWEEN TWO STATIONARY PHASES CONTAINED IN TWO CHROMATOGRAPHY COLUMNS

(71) Applicant: ORANO MED, Chatillon (FR)

(72) Inventors: Julien Torgue, Gaithersburg, MD (US); Rémy Dureau, Saint-Gence (FR)

(21) Appl. No.: 17/293,185

(22) PCT Filed: Nov. 8, 2019
(86) PCT No.: PCT/FR2019/052676

§ 371 Date: May 12, 2021

(30) Foreign Application Priority Data
Nov. 15, 2018 (FR) 1860562

(51) Int. Cl. G01N 30/46; G01N 30/18

(52) U.S. Cl. CPC G01N 30/468; G21G 4/08; G01N 30/18

(57) ABSTRACT

A method for transferring a radioisotope which is fixed on a first stationary phase contained in a first chromatography column to a second stationary phase contained in a second chromatography column, to fix the radioisotope on the second stationary phase, wherein the radioisotope is selected from the radioactive isotopes of thorium, radium, lead, bismuth and uranium, the method comprising at least the following steps: a) eluting the radioisotope from the first stationary phase with an aqueous solution A1 comprising an agent complexing the radioisotope, whereby an aqueous solution A2 which comprises complexes of the radioisotope is obtained; b) dissociating the complexes of the radioisotope present in the aqueous solution A2 by modifying the pH of the aqueous solution A2, whereby an aqueous solution A3 comprising the decomplexed radioisotope is obtained; c) loading the second stationary phase with the aqueous solution A3; and d) washing at least one the second stationary phase with an aqueous solution A4.

### TECHNICAL FIELD

The invention relates to the field of the production of radioactive isotopes, also known as radioisotopes.

More specifically, it relates to a method for transferring a radioisotope which is fixed on a first stationary phase contained in a first chromatography column to a second stationary phase contained in a second chromatography column with a view to fixing this radioisotope on this second stationary phase.

This method can particularly be used to carry out preventive maintenance of radioisotope generators and, in particular, radium-224 generators wherein radium-224 is produced by radioactive decay of thorium-228.

As such, it is likely to find applications in the manufacture of radiopharmaceuticals based on lead-212 or bismuth-212, suitable for use in nuclear medicine and, in particular, in targeted alpha radiotherapy for cancer treatment.

### PRIOR ART

Targeted alpha radiotherapy, also known as targeted alphatherapy, consists of injecting a radioactive isotope bound to a vector, such as an antibody, capable of very precisely targeting specific sites present on the surface of cancer cells. The alpha energy emitted by the natural radioactive decay of the radioisotope then makes it possible to destroy cancer cells while limiting damage to surrounding healthy cells.

Some decay products of thorium-232 and, in particular, lead-212 and bismuth-212, which is the daughter radioisotope of lead-212, can be used in targeted alphatherapy, particularly in the treatment of pancreatic cancers, other intraperitoneal cancers and melanomas, diseases for which targeted alphatherapy has been the subject of preclinical tests, in particular in the USA.

As shown in appended FIG. 1 which represents the natural decay, or disintegration, chain of thorium-232 which includes lead-212 and bismuth-212:
lead-212 can be produced by radioactive decay of radium-224,
radium-224 can be produced by radioactive decay of thorium-228,
thorium-228 can be produced by radioactive decay of radium-228, whereas
radium-228 can be produced by radioactive decay of thorium-232 which represents the main constituent of natural thorium extracted from ores such as monazite or thorite.

The production of radium-224 can be carried out by means of what is known as a radium-224 “generator”, i.e. a chromatography column which typically comprises a solid stationary phase whereon thorium-228 is fixed and which is washed regularly with a liquid phase making it possible to selectively elute the radium-224 which is formed by radioactive decay of thorium-228.

A stationary phase material particularly capable of being used in a radium-224 generator is, for example, that offered by the companies Triskem International and Eichrom, under the designation “DGA DN Resin”, for the separation by chromatography of tri- and tetravalent actinides, in particular, of americium and actinium. This resin consists of particles of a polymethacrylate functionalised with a linear chain diglycolamide, namely N,N,N′,N′-tetraoctyldiglycolamide, better known under the name TODGA.

A limitation to the operation of a radium-224 generator comprising a stationary phase consisting of such a resin is linked with the fact that the resin is degraded progressively by radiolysis, which gradually affects its ability to retain thorium-228 and results after a certain period of use of the generator in the occurrence of leakages of thorium-228 because the resin has lost too much of its retention capacity to be able to retain this radioelement completely.

This radiolytic degradation process of the resin therefore requires regular maintenance of the generator in the form of elutions primarily intended to remove from the resin the thorium-228 decay products having a short life which are responsible for radiolysis, particularly due to the alpha radiation thereof, and limits the peak activity of thorium-228 capable of being fixed per gram of resin (which, beyond a certain threshold, would require an impracticable elution frequency).

However, it is found that, even if the generator undergoes regular maintenance to prevent the occurrence of leakages of thorium-228, there comes a time when the degradation of the resin is such that the occurrence of leakages of thorium-228 can no longer be prevented and when, consequently, the radium-224 generator needs to be scrapped. However, the half-life of thorium-228 being 1.9 years, this scrapping occurs well before half of the thorium-228 present in the generator has been able to disintegrate to radium-224.

The Inventors set themselves the aim of finding a solution for this problem.

However, within the scope of their work, the Inventors observed that it is possible to transfer thorium-228, which is fixed on a first stationary phase, such as the stationary phase of a used radium-224 generator, to a second stationary phase of optionally the same composition as the first stationary phase but free of any prior use, without noteworthy loss of thorium-228 during this transfer. The second chromatography column wherein the second stationary phase is located can then serve, in turn, as a radium-224 generator.

They also observed that it is possible to transfer in the same way and with the same efficiency a radioisotope other than thorium-228 such as a radioisotope of radium, lead, bismuth or uranium, from a first stationary phase to a second stationary phase. In particular, the radioisotope for which the method according to the invention is also applicable can be selected from radium-228, radium-224, lead-212, bismuth-212 and bismuth-213.

The invention is based on these observations.

### DISCLOSURE OF THE INVENTION

Therefore, the invention proposes a method which allows transferring a radioisotope fixed on a first stationary phase contained in a first chromatography column to a second stationary phase contained in a second chromatography column, to fix the radioisotope on the second stationary phase, the radioisotope being selected from the radioactive isotopes of thorium, radium, lead, bismuth and uranium, which method comprises at least the following steps:

a) eluting the radioisotope from the first stationary phase with an aqueous solution A1 comprising an agent complexing the radioisotope, whereby an aqueous solution A2 which comprises complexes of the radioisotope is obtained;

b) dissociating the complexes of the radioisotope present in the aqueous solution A2 by modifying the pH of the aqueous solution A2, whereby an aqueous solution A3 comprising the decomplexed radioisotope is obtained;

c) loading the second stationary phase with the aqueous solution A3; and

d) washing at least once the second stationary phase with an aqueous solution A4.

Thus, according to the invention, the radioisotope which is fixed on the first stationary phase is transferred to the second stationary by eluting this radioisotope from the first stationary phase by means of an aqueous solution which comprises an agent which will elute the radioisotope from the first stationary phase by complexation or chelation (both terms being considered here as synonymous), then, after dissociation of the complexes of the radioisotope present in the eluate thus obtained, by refixing the decomplexed radioisotope on the second stationary phase.

Hereinabove and hereinafter, a radioisotope is considered to be fixed on a stationary phase when it is retained by this phase by complexation or chelation, ion exchange, molecular recognition or any other mechanism not involving the existence of covalent bonds between the radioisotope and the stationary phase.

According to the invention, the complexing (or chelating) agent present in the aqueous solution A1 is, preferably, an aminopolycarboxylic acid or an aminopolycarboxylic acid salt.

Thus, it can particularly consist of nitrilotriacetic acid (or NTA), ethylenediaminetetraacetic acid (or EDTA), diethylenetriaminepentaacetic acid (or DTPA) or of one of the salts thereof, preference being, however, given to EDTA and to the salts thereof such as the sodium salts thereof.

Therefore, the aqueous solution A1 is preferentially a solution which comprises EDTA or a salt thereof, at a concentration advantageously between 10 mmol/L and 100 mmol/L and, more preferably, equal to 25 mmol/L and wherein the pH is between 4 and 8 and, more preferably, is equal to 6±0.5.

The eluate thus obtained—or aqueous solution A2—therefore comprises the radioisotope but in complexed form.

Therefore, step b) is intended to dissociate the complexes of the radioisotope present in the eluate with a view to being able, in step c), to load the second stationary phase with an aqueous solution comprising the decomplexed or, in other words, free radioisotope.

According to the invention, this dissociation is carried out by modifying the pH of the aqueous solution A2 so as to bring this pH to a value at which the ability of the complexing agent to complex the radioisotope is reduced or zero.

Thus, for example, if the complexing agent is EDTA or one of the salts thereof, the dissociation of the complexes of the radioisotope is carried out by acidifying the aqueous solution A2 to bring the pH of this solution to a value at which EDTA is found mostly in cationic form, i.e. at most equal to 1.

This acidification can be carried out by simply adding an acid, for example nitric or hydrochloric acid, to the aqueous solution A2.

However, within the scope of the invention, the acidification of the aqueous solution A2 is preferably carried out by performing at least one washing of the first stationary phase with an acidic aqueous solution, for example nitric or hydrochloric acid, and by adding all or part of the aqueous solution issued from this washing to the aqueous solution A2.

More preferably, to acidify the aqueous solution A2, it is preferred to wash the first stationary phase twice:
a first time with an acidic aqueous solution whose acid concentration is suitably selected so that the washing does not favour the retention by the first stationary phase of the complexes of the radioisotope and any possible traces of the non-complexed radioisotope retained in the interstitial volume of the first stationary phase;
a second time with an acidic aqueous solution typically of a higher acidity than the previous one.

Indeed, it is advantageous to proceed in this way as this makes it possible not only to acidify the aqueous solution A2 but also to retrieve the complexes of the radioisotope and any possible traces of the non-complexed radioisotope retained in the interstitial volume of the first stationary phase.

When the acidification of the aqueous solution A2 is carried out by adding one or more solutions issued from the washing of the first stationary phase, then the method can comprise, between steps b) and c), a monitoring of the pH of the aqueous solution A3 which is obtained following this acidification and, if required, an adjustment of this pH to a value at most equal to 1 by adding an acid, for example nitric or hydrochloric acid.

In step c), the loading of the second stationary phase with the aqueous solution A3 consists advantageously of simply circulating this solution in the second chromatography column but carried out, preferably at a low flow rate, for example from 0.1 mL/min to 5 mL/min, so as to favour the retention of the radioisotope at the head of the column.

As mentioned above, in step d), the second stationary phase is subjected to at least one washing with an aqueous solution A4 to, on one hand, remove the free complexing agent which is retained in the interstitial volume of the second stationary phase and, on the other hand, condition the second stationary phase with a view to the subsequent use of the second chromatography column, for example as a radioisotope generator.

The aqueous solution A4 is, preferably, an acidic aqueous solution, for example of nitric or hydrochloric acid, whose concentration is suitably selected to prevent the complexing agent retained in the interstitial volume of the second stationary phase from precipitating while keeping the retention of the radioisotope by this stationary phase at its optimum.

Thus, if the complexing agent is EDTA or one of the salts thereof, the acid concentration of the aqueous solution A4 is advantageously between 0.5 mol/L and 4 mol/L and, more preferably, equal to 0.5 mol/L if the acid is nitric acid, whereas it is advantageously between 2 mol/L and 4 mol/L and, more preferably, equal to 2 mol/L if the acid is hydrochloric acid.

According to the invention, the method can further comprise, before step a), a step of conditioning the first stationary phase, i.e. a step aimed at bringing the acidity, which prevails in the interstitial volume of this phase due to the prior use thereof, to a value suitable for preventing, during step a), any risk of precipitation of the complexing agent present in the aqueous solution A1.

Typically, this conditioning is carried out by washing the first stationary phase with an acidic aqueous solution, for example of nitric or hydrochloric acid, whose acidity is less than that prevailing in the interstitial volume of the first stationary phase.

Each of the first and second stationary phases consists of a stationary phase material, which can be identical for both phases or, contrariwise, different from one phase to the other according to the purpose of the transfer of the radioisotope.

Thus, for example, if the transfer of the radioisotope is performed within the scope of a preventive maintenance of a radium-224 generator, i.e. to anticipate leakages of thorium-228 from this generator, then the first and second stationary phases consist of the same stationary phase material.

On the other hand, if, for example, the transfer of the radioisotope is performed to obtain different elution profiles for the decay products thereof, or to move this radioisotope to a stationary phase more resistant to radiation than that whereon it is located, then the first and second stationary phases can consist of two different stationary phase materials.

In a manner known per se, the stationary phase material(s) can comprise a solid substrate that is mineral (such as silica or alumina particles or a silica gel), organic (such as a polymer or copolymer) or inorganic-organic which is functionalised, for example by grafting or impregnation, by organic molecules capable of retaining by complexing, ion exchange, molecular recognition or any other mechanism, the ions of the chemical element of which the radioisotope is a radioactive isotope, for example, thorium ions if the radioisotope is thorium-228.

In a particularly preferred implementation of the invention, the radioisotope is thorium-228, in which case the first stationary phase and/or the second stationary phase consist(s), preferably, of particles comprising a polymer functionalised by molecules of a ligand of thorium.

Advantageously, the polymer is a polymethacrylate or a poly(styrene-co-divinylbenzene), whereas the ligand of thorium-228 is N,N,N′,N′-tetraoctyldiglycolamide (or TODGA), di(2-ethylhexyl)phosphoric acid (or HDEHP), trioctylphosphine oxide (or TOPO) or a mixture thereof.

Stationary phase materials of this type are particularly available from the companies Triskem International and Eichrom.

According to the invention, the method can advantageously be implemented to carry out the maintenance of a plurality (at least two) generators (i.e. several first columns) from which a plurality of eluates are collected (step a) of the method) which, after treatment (step b) of the method), are loaded (step c) of the method) in the same second column, which constitutes, after washing (step d) of the method), a new generator.

Further features and advantages of the method according to the invention will emerge on reading the following supplementary description and which relates to an example of implementation of this method.

Obviously, this implementation is merely given by way of illustration of the subject matter of the invention, and in no way represents a restriction of this subject matter.

### BRIEF DESCRIPTION OF THE FIGURES

FIG. 1, previously described, represents the radioactive decay chain of thorium-232.

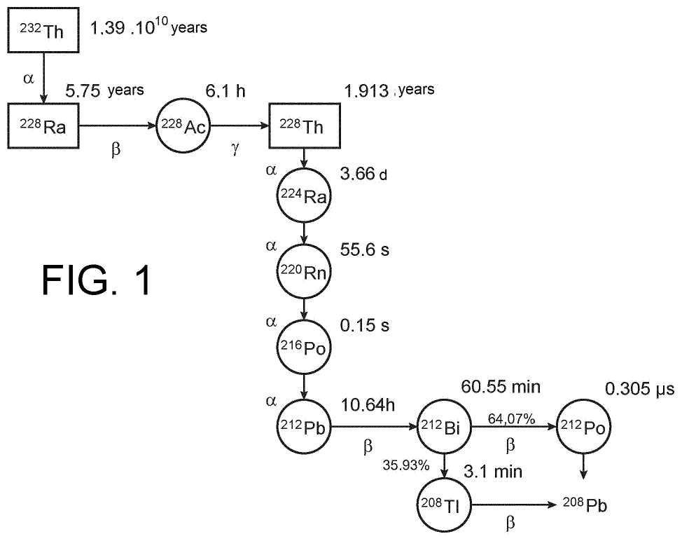

FIG. 2 schematically represents the different steps of an example of implementation of the method according to the invention.

### DETAILED DISCLOSURE OF A SPECIFIC IMPLEMENTATION

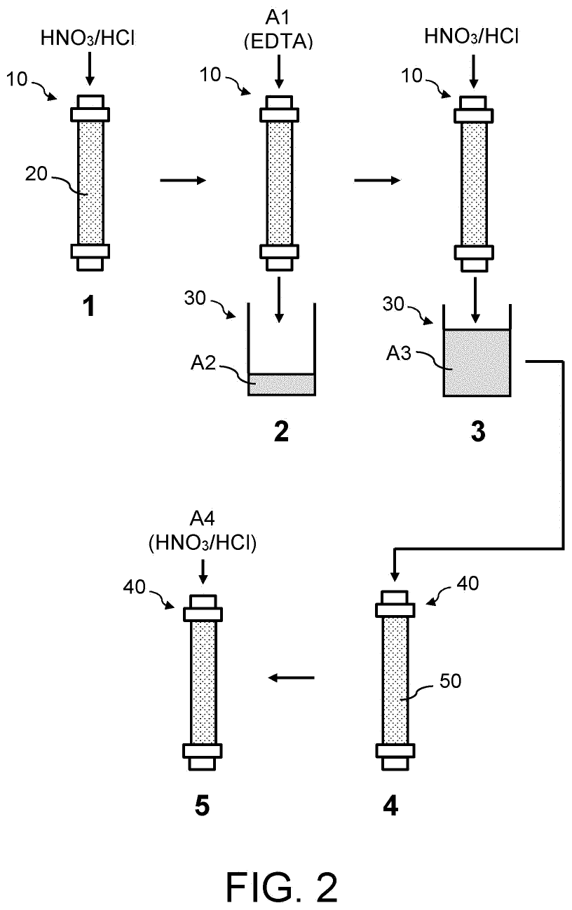

Reference is made to FIG. 2 which represents schematically the different steps of an example of implementation of the method according to the invention for transferring thorium-228 from a first DGA DN resin, referenced 20, contained in a first chromatography column, referenced 10, to a second DGA DN resin, referenced 50, contained in a second chromatography column 40.

The first chromatography column 10 is, for example, a used radium-224 generator whereas the second chromatography column 40 is intended to constitute a new radium-224 generator.

In this implementation, the method comprises the following steps:

1. conditioning the resin 20 with an aqueous nitric or hydrochloric acid solution;

2. eluting the thorium-228 fixed on the resin 20 with an aqueous solution A1 which comprises EDTA, and collecting in a receptacle, referenced 30, such as a beaker, flask or similar, the eluate—or aqueous solution A2—comprising thorium-228 in the form of EDTA-²²⁸Th complexes;

3. dissociating the EDTA-²²⁸Th complexes by acidifying the eluate to bring its pH to a value at most equal to 1, whereby an aqueous solution A3 comprising decomplexed thorium-228 is obtained;

4. loading the resin 50 with the aqueous solution A3 to fix on this resin the decomplexed thorium-228 resin present in this solution; and

5. washing the stationary phase 50 with an aqueous nitric or hydrochloric acid solution A4.

All these steps, which are detailed hereinafter, are performed at ambient temperature, i.e. at a temperature of 20° C. to 25° C.

*Step 1:

The column 10 comprises a DGA DN resin (Triskem International/Eichrom) 20 loaded with thorium-228.

This type of resin, which is presented in particle form, retains thorium, regardless of the isotope, but does not retain radium, regardless of the isotope.

The resin 20 was subjected to several production cycles of radium-224 each comprising a period during which thorium-228 was allowed to produce radium-224 by radioactive decay followed by an elution of the radium-224 thus produced.

These elutions having been carried out with 2 mol/L nitric acid or 3 mol/L hydrochloric acid solutions, the resin 20 is firstly conditioned to lower the acidity prevailing in the interstitial volume of this resin so as to prevent the EDTA used in step 2 hereinafter from precipitating during this step.

This conditioning is carried out by circulating in the column 10 several BVs, for example 3 BVs, at a flow rate between 0.1 mL/min and 5 mL/min, of an aqueous solution which comprises either nitric acid or hydrochloric acid—with a preference for nitric acid—at a concentration substantially less than or equal to that exhibited by the solutions having been used for the elutions of radium-224.

This concentration is, for example, 0.5 mol/L for an aqueous nitric acid solution and 2 mol/L for an aqueous hydrochloric acid solution.

*Step 2:

The elution of the thorium-228 from the resin 20 is carried out by circulating in the column 10 several BVs of aqueous solution A1, which typically comprises from 10 mmol/L to 100 mmol/L and, preferably, 25 mmol/L of EDTA and has a pH of 4 to 8 and, preferably, equal to 6±0.5.

For an optimal elution, 10 BVs of aqueous solution A1 are used at a flow rate ranging from 0.1 mL/min to 5 mL/min and, preferably, equal to 1 mL/min, the 10 BVs optionally being circulated continuously (i.e. in one go) or discontinuously, i.e. in two goes separated by one another by a break of a few minutes.

*Step 3:

As mentioned above, this step consists of acidifying the eluate—or aqueous solution A2—collected in step 2 in the receptacle 30 to bring the pH of this eluate to a value at most equal to 1.

This acidification makes it possible not only to obtain a dissociation of the EDTA-²²⁸Th complexes present in the eluate since the EDTA is in cationic form at a pH equal to or less than 1 but also to give the eluate a favourable pH for a retention of thorium-228 on a DGA DN resin. These two combined effects therefore make it possible to refix thorium-228 on the resin 50 in step 4 hereinafter.

The acidification of the eluate can be carried out:
either by simply adding nitric or hydrochloric acid—with a preference for nitric acid—to the eluate present in the receptacle 30;
or, as illustrated in FIG. 2, by subjecting the resin 20 to two successive washings, each of these washings being carried out with an acidic aqueous solution, and adding the solutions from these washings to the eluate present in the receptacle 30.

The first washing is, for example, carried out by circulating in the column 10 several BVs, for example 3 BVs, of an aqueous solution comprising:
either from 0.01 mol/L to 0.1 mol/L and, preferably, 0.1 mol/L of nitric acid;
either from 0.1 mol/L to 1 mol/L and, preferably, 0.1 mol/L of hydrochloric acid.

The second washing is, for example, carried out by circulating in the column 10 several BVs, for example 3 BVs, of an aqueous solution comprising:
either from 0.5 mol/L to 4 mol/L and, preferably, 0.5 mol/L of nitric acid;
either from 2 mol/L to 4 mol/L and, preferably, 2 mol/L of hydrochloric acid.

In both cases, preference is given, once again, to aqueous nitric acid solutions.

The circulation rates in the column 10 of the aqueous solutions used for the washings are advantageously from 0.1 mL/min to 5 mL/min.

As illustrated in FIG. 2, the solutions issued from the washings can be collected directly, at the outlet of the column 10, in the receptacle 30 wherein the eluate is located.

Alternatively, they can be collected in a receptacle other than the receptacle 30 and then be added to the eluate present in the receptacle 30.

It should be noted that, during the acidification of the eluate, EDTA can precipitate then be redissolved virtually entirely. Also, regardless of the methods selected to acidify the eluate, it is preferable for this acidification to be carried out under stirring to ensure a homogeneity of the acidified eluate—or aqueous solution A3—and, therefore, its stability, once the EDTA has redissolved.

As a precautionary measure, the aqueous solution A3 can optionally be filtered, for example by means of a filter of porosity 0.2 μm, before proceeding with step 4.

*Step 4:

The column 40 is, preferably completely identical to the column 10, with the same bed volume and the same mass quantity of DGA DN resin, except that this resin is free from any prior use.

The loading of the column 40 with the aqueous solution A3 is carried out by circulating this solution in the column 40, preferably at a low flow rate, for example from 0.1 mL/min to 5 mL/min, so as to favour the retention of the thorium-228 at the head of the column.

*Step 5:

The washing of the resin 50 is carried out by circulating in the column 40 several BVs of aqueous solution A4, which typically comprises:
from 0.5 mol/L to 4 mol/L and, preferably, 0.5 mol/L of nitric acid; or
from 2 mol/L to 4 mol/L and, preferably, 2 mol/L of hydrochloric acid.

Once again, preference is given to nitric acid.

For optimal washing, 20 BVs of aqueous solution A4 are used at a flow rate ranging from 0.1 mL/min to 5 mL/min and, preferably, equal to 2.5 mL/min.

The implementation of the method according to the invention using a column 10 and a column 40 each having a BV of 7.2 mL and each containing 3.3 g of DGA DN resin (particle size: 50-100 μm) as well as the following operating parameters:
step 1: conditioning of the resin 20 by circulation in the column 10 of 5 BVs of an aqueous solution comprising 0.5 mol/L of nitric acid, at a flow rate of 0.5 mL/min;
step 2: elution of thorium-228 by circulation in the column 10 of 10 BVs of an aqueous solution A1 comprising 25 mmol/L of EDTA and of pH equal to 6±0.5, at a flow rate of 1 mL/min;
step 3: addition to the aqueous solution A2 from step 2 of 2 BVs of a nitric acid solution comprising about 14 mol/L of HNO₃ (i.e. 65% by mass);
step 4: loading of the resin 50 by circulation in the column 40 of the 12 BVs obtained in step 3, at a flow rate of 2.5 mL/min;
step 5: washing of the resin 50 by circulation in the column 40 of 5 BVs of an aqueous solution A4 comprising 0.5 mol/L of nitric acid, at a flow rate of 0.5 mL/min; made it possible to transfer more than 99% of the activity of the thorium-228 retained by the resin contained in the column 10 at the time t0 of the implementation of the method to the resin contained in the column 40.

What is claimed is:

1. A method for transferring a radioisotope which is fixed on a first stationary phase contained in a first chromatography column to a second stationary phase contained in a second chromatography column, to fix the radioisotope on the second stationary phase, the radioisotope being a radioactive isotope of thorium, radium, lead, bismuth or uranium, which comprises at least the following steps:
a) eluting the radioisotope from the first stationary phase with an aqueous solution A1 comprising an agent complexing the radioisotope, whereby an aqueous solution A2 which comprises complexes of the radioisotope is obtained;
b) dissociating the complexes of the radioisotope present in the aqueous solution A2 by modifying a pH of the aqueous solution A2, whereby an aqueous solution A3 comprising the radioisotope in decomplexed form is obtained;
c) loading the second stationary phase with the aqueous solution A3; and
d) washing at least once the second stationary phase with an aqueous solution A4.

2. The method of claim 1, wherein the agent complexing the radioisotope is an aminopolycarboxylic acid or an aminopolycarboxylic acid salt.

3. The method of claim 2, wherein the aminopolycarboxylic acid is nitrilotriacetic acid, ethylenediaminetetraacetic acid or diethylenetriaminepentaacetic acid.

4. The method of claim 1, wherein the aqueous solution A1 comprises from 10 mmol/L to 100 mmol/L of ethylenediaminetetraacetic acid or a salt thereof and has a pH of 4 to 8.

5. The method of claim 4, wherein the aqueous solution A1 comprises 25 mmol/L of ethylenediaminetetraacetic acid or a salt thereof and has a pH of 6±0.5.

6. The method of claim 1, wherein the modification of the pH of the aqueous solution A2 is an acidification to bring the pH of the aqueous solution A2 to a value at most equal to 1.

7. The method of claim 6, wherein the acidification of the aqueous solution A2 comprises an addition of an acid to the aqueous solution A2.

8. The method of claim 6, wherein the acidification of the aqueous phase A2 comprises at least one washing of the first stationary phase with an acidic aqueous solution and an addition of all or part of the aqueous solution issued from the washing to the aqueous solution A2.

9. The method of claim 8, wherein the acidic aqueous solution comprises from 0.01 mol/L to 0.1 mol/L of nitric acid or from 0.1 mol/L to 1 mol/L of hydrochloric acid.

10. The method of claim 1, wherein the aqueous solution A4 comprises from 0.5 mol/L to 4 mol/L of nitric acid or from 2 mol/L to 4 mol/L of hydrochloric acid.

11. The method of claim 1, which further comprises, before step a), a step of conditioning the first stationary phase.

12. The method of claim 1, wherein the first stationary phase consists of a first stationary phase material, the second stationary phase consists of a second stationary phase material and the first and second stationary phase materials are identical.

13. The method of claim 1, wherein the first stationary phase consists of a first stationary phase material, the second stationary phase consists of a second stationary phase material and the first and second stationary phase materials are different.

14. The method of claim 1, wherein the radioisotope is thorium-228.

15. The method of claim 14, wherein at least one of the first stationary phase and second stationary phase consists of particles comprising a polymer functionalised by molecules of a ligand of thorium.

16. The method of claim 15, wherein the polymer is a polymethacrylate or a poly(styrene-co-divinylbenzene), and the ligand of thorium-228 is N,N,N′,N′-tetraoctyldiglycolamide, di(2-ethylhexyl)phosphoric acid, trioctylphosphine oxide or a mixture thereof.

17. The method of claim 3, wherein the aminopolycarboxylic acid is ethylenediaminetetraacetic acid

18. The method of claim 7, wherein the acid is nitric or hydrochloric acid.
